(19) United States
(12) Patent Application Publication
(10) Pub. No.: US 2003/0213474 A1
(43) Pub. Date: Nov. 20, 2003

(54) Engine control method and apparatus using a fuel volatility sensor

(76) Inventors: David K. Lambert, Sterling Heights, MI (US); Gary Charles Abusamra, Grand Blanc, MI (US); Charles Robert Harrington, Troy, MI (US); John E. Kirwan, Troy, MI (US); Han-Sheng Lee, Bloomfield Hills, MI (US); Michael Joseph Niemiec, Brighton, MI (US)

Correspondence Address: VINCENT A. CICHOSZ, DELPHI TECHNOLOGIES, INC., Legal Staff, Mail Code: 480-414-420, P.O. Box 5052, Troy, MI, 48007-5052, US

(21) Appl. No.: 10/146,743

(22) Filed: May 16, 2002

(51) Int. Cl. F02M 51/00

(52) U.S. Cl. 123/491

(57) ABSTRACT

The invention provides an improvement over conventional engine controls by directly measuring fuel volatility, and using this measured value to adjust the engine air/fuel ratio during engine start and initial operation. Engine startability and initial operation are improved as compared to conventional engine control systems by compensating the engine air/fuel ratio during engine start and initial engine operation, using a direct measurement of the fuel volatility.

### TECHNICAL FIELD

This invention pertains generally to internal combustion engine control systems, and more specifically to a method and apparatus designed to compensate for variations in fuel volatility using feedback from a sensor that measures the fuel volatility.

### INCORPORATION BY REFERENCE

Applicant incorporates by reference co-pending application Ser. No. 10/062,581; Fuel Sampling Method and Apparatus, in that the method and apparatus for fuel sampling need not be fully described in detail herein.

### BACKGROUND OF THE INVENTION

The need to be able to effectively start and run an internal combustion (IC) engine using fuels with a range of properties has been a constant problem. Included in the fuel properties is the vapor pressure of the fuel, which is quantified by the Reid Vapor Pressure (RVP) or the Driveability Index (DI). Fuel refiners and distributors adjust the fuel vapor pressure to correspond to seasonal ambient temperatures in order to optimize the cold start capability of IC engines in various geographic regions. This variation in vapor pressure is created by balancing the amount of lower-, mid-, and heavier-weight hydrocarbon molecules in the fuel. The lower weight hydrocarbon molecules vaporize at lower temperatures, thus leading to more effective engine startability at low ambient temperatures. The fuel available can range in DI from under 1000 (highly volatile) in cooler areas to over 1250 (very stable) in hotter areas.

The fuel in a fuel tank may also change vaporization characteristics over time, through a process called ‘weathering’. The lower-weight hydrocarbon molecules may evaporate in the fuel tank. Passenger cars and trucks have evaporative systems that capture and store these evaporated hydrocarbons in a carbon canister and subsequently consume them by purging the canister through the engine. In engine applications where there is no evaporative system, these lower weight molecules may be vented to the atmosphere. Either way, the evaporative characteristics of the fuel remaining will have changed, and the suitability of the fuel for cold start operation will have also changed.

Engine manufacturers are faced with meeting requirements for stable start and run conditions. To meet the driveability requirements, engine management systems are calibrated using a sufficient amount of fuel to be robust when fuels of varying volatility are encountered. A typical approach to managing varying levels of fuel volatility has been to calibrate the system with excess fuel to ensure good driveability. This use of excess fuel increases engine-out hydrocarbon and carbon monoxide emissions unnecessarily. In addition, the vehicle manufacturers must also comply with more stringent exhaust emissions regulations. An important strategy in meeting the emissions regulations is to ensure that the engine runs at an air/fuel ratio that is at or near stoichiometry at the start of the engine, or soon thereafter. This is necessary to minimize engine out emissions and also to provide an exhaust gas feedstream to a catalytic converter that allows the converter to perform at optimum levels.

Engine and vehicle manufacturers accomplish this balance between meeting customer requirements for stable operation and meeting emissions regulations several ways. Extensive testing and calibration is conducted during the engine development phase. Hardware such as air injection pumps will be added. The amount of precious metals (Palladium, Rhodium, and Platinum) contained in the catalytic converter is increased to improve effective conversion of pollutants. Each of these methods adds complexity and cost to the vehicle or engine.

Several methods have been proposed to control engine performance based upon fuel volatility by monitoring the engine during initial operation. These methods infer volatility from other measured parameters, including engine speed, cylinder pressure ratio, or exhaust gas temperature measurement. Examples of these methods are described in U.S. Pat. No. 6,283,102, entitled Fuel Identifier Algorithm, issued to Nelson on Sep. 4, 2001, U.S. Pat. No. 6,178,949, entitled Engine Control Having Fuel Volatility Compensation, issued to Kirwan on Jan. 30, 2001, and U.S. Pat. No. 5,875,759, entitled Method for Improving Spark Ignited Internal Combustion Engine Starting And Idling Using Poor Driveability Fuels, issued to Meyer on Mar. 2, 1999.

Each of these methods carries the disadvantage that they do not directly measure the volatility of the fuel. Therefore any compensation scheme can be skewed because of incorrect assumptions in the inference chain from the measured parameter to a useable parameter, i.e. volatility. Each method also requires varying levels of testing and evaluation during engine calibration and development to establish the inference chains and create calibration tables that can be used by an engine controller. Each method also may have to be regularly reset to a nominal value during the operation of the vehicle due to external changes for which the given method is unable to adjust, e.g. vehicle refueling with a different volatility of fuel.

### SUMMARY OF THE INVENTION

The present invention provides an improvement over conventional engine controls by directly measuring fuel volatility, and using this measured volatility to adjust the engine air/fuel ratio during engine start and initial operation. This adjustment of the engine air/fuel ratio ensures that a sufficient quantity of vaporized fuel will be delivered to the engine to effectively start and operate it. The present invention is an apparatus that is comprised of a sensing unit capable to directly measure volatility of the fuel that is being delivered to an engine. This sensing unit is a part of an engine control system, and supplies input to an engine controller. The present invention also comprises a method to control the engine based upon a measure of fuel volatility. The engine controller integrates the input from the volatility sensing unit with that from other sensors to calculate an amount of fuel to deliver to the engine during starting and operation. The engine controller will then use this calculated amount of fuel to drive a fuel delivery system to deliver a proper amount of air.

The present invention provides an improvement in the engine startability as compared to conventional engine control systems. The invention compensates the engine air/fuel ratio during engine start and during initial engine operation, based upon the direct measurement of the fuel volatility.

These and other objects of the invention will become apparent to those skilled in the art upon reading and understanding the following detailed description of the embodiments.

### BRIEF DESCRIPTION OF THE DRAWINGS

The invention may take physical form in certain parts and arrangement of parts, the preferred embodiment of which will be described in detail and illustrated in the accompanying drawings which form a part hereof, and wherein:

FIG. 1 is a diagram of an engine and fuel system, in accordance with the present invention;

FIG. 2 is a diagram of an alternate embodiment of the invention, wherein the fuel sensing unit is located in the fuel rail;

FIG. 3 is a flow diagram in accordance with the present invention.

### DETAILED DESCRIPTION OF THE PREFERRED EMBODIMENT

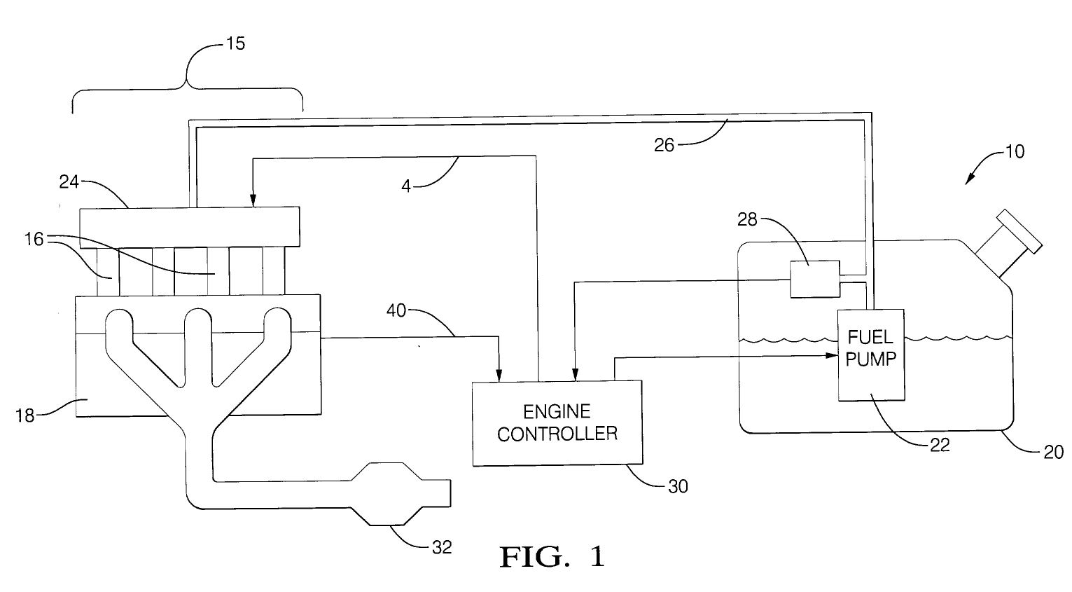

Referring now to the drawings, wherein the showings are for the purpose of illustrating the preferred embodiment of the invention only and not for the purpose of limiting the same, FIG. 1 shows an internal combustion engine and control system 10 which has been constructed in accordance with an embodiment of the present invention. The engine 18 includes one or more cylinders that convert the stored energy of fuel to power in the form of rotational and linear motion. The engine 18 supplies power to driveline and accessory components (not shown). This operation is well known in the art.

An engine control system is made up of an electronic engine controller 30, sensors 40, and various output devices (not shown), wherein the controller collects information from the sensors 40 and drives output devices (not shown) in accordance with predetermined algorithms and calibration tables (not shown). During typical engine operation, sensors 40 monitor one or more predetermined engine parameters and a mass of air (not shown) delivered to the engine is determined, based on the sensed parameters. The mass of air (not shown) delivered can be determined by direct measurement, using a mass air flow sensor (not shown), or it can be determined by estimation based upon sensed parameters including for example, a manifold absolute pressure sensor (not shown), a coolant temperature sensor (not shown), and a throttle position sensor (not shown). The engine control system can then provide output to the various systems of the engine 18. These systems include the fuel system 15, which delivers a specific amount of fuel to the engine 18 to achieve a desired air/fuel ratio, based on a mass of air delivered. The governing equation used by the engine controller to calculate the amount of fuel to deliver is:

Fuel Delivered=[Mass of Air]/[Air/Fuel Ratio].

The air/fuel ratio is controlled to ensure that a catalytic converter system 32 operates at an optimal level for given engine operating and ambient conditions. The air/fuel ratio is continually monitored and optimized to accommodate changes in inputs to the engine, changes in engine operating conditions, and changes in operator demands. This method of controlling an engine is well known to those skilled in the art.

The present invention comprises an engine controller 30 that controls an internal combustion engine 18 during engine start and operation based upon a direct measurement of fuel volatility. The fuel system 15 includes one or more fuel injectors 16 that deliver fuel to the engine. The injectors 16 are connected to one or more fuel rails 24 that serve as manifold devices for supplying fuel to each fuel injector 16. Each fuel rail 24 may also have other characteristics such as the capability to regulate fuel pressure or reduce inconsistencies in pressure or flow between the fuel injectors 16. The fuel system 15 is in fluid connection with a fuel storage tank 20 via a fuel line 26, wherein a fuel pump 22 is also employed to provide a sufficient quantity of fuel at a desired pressure level. The fuel pump 22 may also be connected to the engine controller 30. There will also be a fuel sensing unit 28 located in the fuel line 26 near the fuel pump 22. The fuel sensing unit 28 is operable to measure volatility of fuel being delivered to the engine 18, and provide this information to the engine controller 30. As noted earlier, co-pending application Ser. No. 10/062,581 is incorporated by reference to describe the specific fuel sampling method and apparatus. The fuel sensing unit 28 is located in the fuel tank 20 between the fuel pump 22 and the fuel system 15. The engine controller 18 is then able to control the amount of fuel delivered to the engine based upon a desired air/fuel ratio, measured fuel volatility and the intake of air mass. The governing equation used by the engine controller to calculate the amount of fuel to deliver becomes:

Fuel Delivered=F*[Mass of Air]/[(Air/Fuel Ratio)],

where F is a factor that is a function of the fuel volatility. It may also be a function of other variables such as temperature or air pressure in an intake manifold (not shown). The factor F is intended to maintain the ratio of [Air Mass]/[Fuel Mass] in a charge that enters the engine 18 at a desired value. In particular, one portion of fuel that is injected into the intake manifold promptly evaporates and enters the engine 18 as fuel vapor. Another portion of fuel that is injected into the intake manifold initially remains as liquid fuel in the intake manifold and subsequently evaporates. The portion of fuel that promptly evaporates will be a function of volatility of the fuel as well as temperature and air pressure in the intake manifold (not shown).

The fuel volatility measured by the fuel sensing unit 28 that is used by the engine controller 30 may be measured during a previous engine operating cycle. Measuring the volatility of the fuel in the fuel line 26 ensures that the measured value of fuel volatility will accurately represent volatility of the fuel that will be delivered to the engine during a subsequent engine start and initial operation.

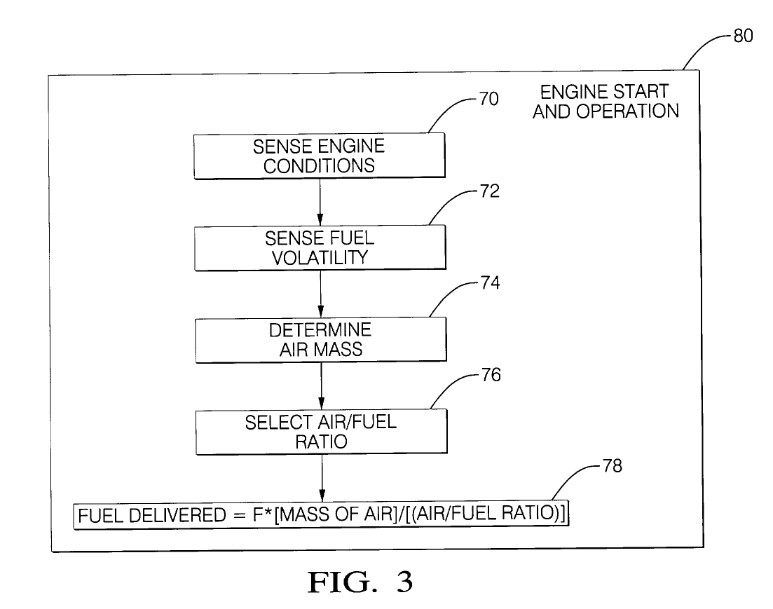

Referring now to FIG. 3, the invention includes a method 80 for controlling an internal combustion engine 18 during engine start and initial operation based upon fuel volatility. In step 70, the method senses engine conditions, with sensors (not shown) on an engine 18. Fuel volatility is then measured in step 72. The method then determines the intake air mass using the sensed engine conditions in step 74, and selects a desired air/fuel ratio to start the engine based upon those sensed engine conditions in step 76. The method then uses the engine controller 18 to control the amount of fuel delivered to the engine based upon the desired air/fuel ratio, the fuel volatility and the intake of air mass in step 78. The factor F in step 78 is a function of the fuel volatility from step 72. It may also be a function of other variables from step 70 such as a temperature in the intake manifold and an air pressure in the intake manifold.

The method will measure the fuel volatility by taking a sample of the fuel in the fuel line 26 between the fuel pump 22 and the fuel injectors 24, preferably in the fuel tank 20. It will then measure the volatility of this sample and input this measurement to the engine controller 30. This method also includes measuring volatility during a previous engine operating cycle. Regardless of when the volatility of the fuel is measured, the intent of the method is to operate the engine so the measured value of fuel volatility will accurately represent the volatility of the fuel being delivered to the engine during engine start and initial operation.

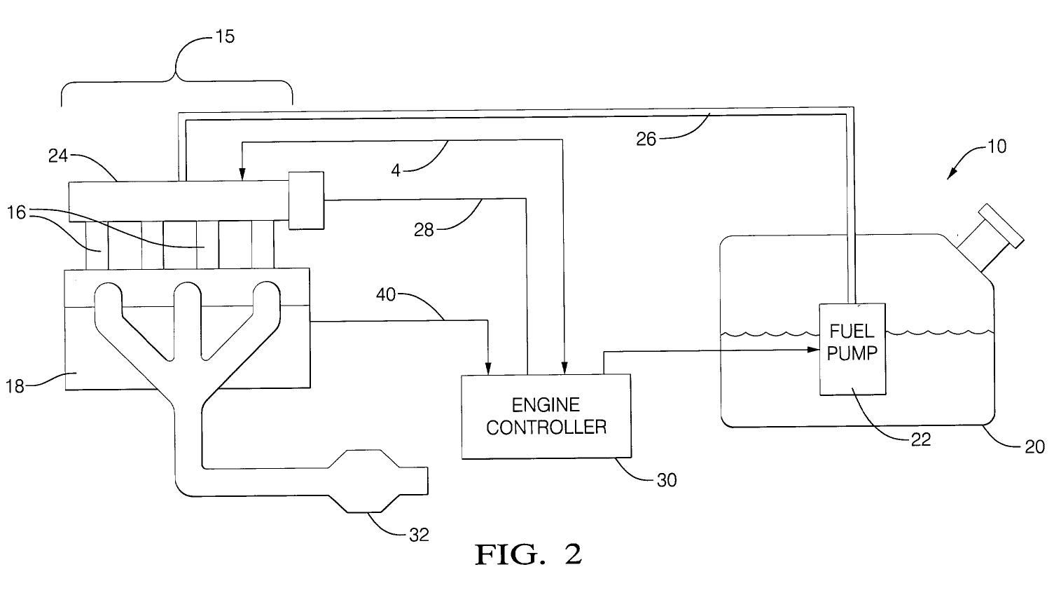

Although this is described as a system using a single fuel tank and fuel supply system, it is understood that alternate embodiments of this invention can include vehicle systems using multiple fuel tanks, or multiple fuel pumps. FIG. 2 is a diagram of an alternate embodiment of the invention. The basic system components are the same as shown in FIG. 1, using the same reference numerals. The specific difference is that the sensing unit 28 is located on the fuel rail 24, rather than in the fuel tank 20. The operation of the system remains unchanged.

The invention has been described with specific reference to the preferred embodiments and modifications thereto. Further modifications and alterations may occur to others upon reading and understanding the specification. It is intended to include all such modifications and alterations insofar as they come within the scope of the invention. This includes fuel systems that comprise one or more fuel tanks, or one or more fuel pumps. It also includes alternate embodiments wherein the fuel volatility sensor is located in other places in the fuel system, such as the fuel line.

Having thus described the invention, it is claimed:

1. A system for controlling an internal combustion engine during engine start, comprising:
an engine having a plurality of sensors operable to sense engine conditions;
a fuel system operable to deliver an amount of fuel to said engine;
a sensing unit operable to measure a fuel volatility; and
an engine controller, said engine controller operable to determine an intake of air mass to the engine as a function of sensed engine conditions, select a desired air/fuel ratio to start said engine as a function of said sensed engine conditions, and control the amount of fuel delivered to the engine as a function of said desired air/fuel ratio, said fuel volatility and said intake of air mass.

2. The control system of claim 1, wherein the fuel volatility is measured during a previous engine on cycle.

3. The control system of claim 1, wherein the sensing unit operable to measure the fuel volatility is located in a fuel line between a fuel pump and a fuel rail.

4. The control system of claim 1, wherein the sensing unit operable to measure the fuel volatility is located in a fuel rail.

5. The control system of claim 1, wherein the sensing unit operable to measure fuel volatility includes means for sampling a quantity of fuel in a fuel line between a fuel pump and a fuel rail, and a sensor operable to measure fuel volatility.

6. The control system of claim 1, wherein the sensing unit operable to measure fuel volatility includes a sensor that has direct contact with fuel flowing in a fuel line.

7. The control system of claim 1, wherein the control of an amount of fuel delivered to an engine as a function of said desired air/fuel ratio, said fuel volatility and said intake of air mass occurs during a cold start.

8. A system for controlling an internal combustion engine during initial engine operation as a function of fuel volatility, comprising
an engine having a plurality of sensors operable to sense engine conditions;
a fuel system operable to deliver an amount of fuel to said engine;
a sensing unit operable to measure a fuel volatility; and
an engine controller, said engine controller operable to determine an intake of air mass to the engine as a function of sensed engine conditions, select a desired air/fuel ratio to operate said engine as a function of said sensed engine conditions, and control the amount of fuel delivered to the engine as a function of said desired air/fuel ratio, said fuel volatility and said intake of air mass.

9. The control system in claim 8, wherein the fuel volatility is measured during a previous engine on cycle.

10. The control system in claim 8, wherein the sensing unit operable to measure the fuel volatility is located in a fuel line between a fuel pump and a fuel rail.

11. The control system of claim 8, wherein the sensing unit operable to measure fuel volatility includes means for sampling a quantity of fuel in a fuel line between a fuel pump and a fuel rail, and a sensor operable to measure fuel volatility.

12. The control system in claim 8, wherein the sensing unit operable to measure the fuel volatility is located in a fuel rail.

13. The control system of claim 8, wherein the control of an amount of fuel delivered to an engine as a function of said desired air/fuel ratio, said fuel volatility and said intake of air mass occurs during initial engine operation.

14. A control system for controlling an internal combustion engine during engine start and operation, comprising:
a sensing unit operable to measure fuel volatility;
said sensing unit in communication with an engine controller;
wherein said engine controller is operable to control an amount of fuel delivered to the engine based upon the measured fuel volatility.

15. The control system of claim 14, wherein the sensing unit measures fuel volatility during a previous engine operating cycle.

16. A control system for controlling an internal combustion engine during engine start and operation, comprising:
an engine with a plurality of sensors operable to sense engine conditions;
a fuel system operable to deliver an amount of fuel to said engine;
a sensing unit operable to measure fuel volatility; and
an engine controller, said engine controller operable to determine an intake of air mass to the engine based upon sensed engine conditions, select a desired air/fuel ratio to operate said engine based upon said sensed engine conditions, and control the amount of fuel delivered to said engine based upon said desired air/fuel ratio, said fuel volatility and said intake of air mass.

17. The control system of claim 16, wherein the fuel volatility is measured during a previous engine operating cycle.

18. The control system of claim 16, wherein the sensing unit comprises means for sampling a quantity of fuel in a fuel line between a fuel pump and a fuel rail and a sensor operable to measure fuel volatility.

19. A method for controlling an internal combustion engine during initial engine operation, comprising:
providing said engine with a fuel system, an engine controller, a plurality of sensors, and a fuel volatility sensor;
sensing engine conditions using the plurality of sensors;
sensing fuel volatility with a sensing unit;
determining an intake of air mass to the engine as a function of sensed engine conditions;
selecting a desired air/fuel ratio to operate said engine as a function of said sensed engine conditions; and
controlling an amount of fuel to be delivered to the engine as a function of said desired air/fuel ratio, said fuel volatility and said intake of air mass.

20. The method of claim 19, wherein the step of sensing fuel volatility comprises measuring volatility during a previous engine on cycle.

21. The method of claim 20, wherein the step of sensing fuel volatility with a sensing unit comprises sampling a quantity of fuel in a fuel line between a fuel pump and a fuel injector, and measuring a volatility of said quantity of fuel with a sensor.

22. The method of claim 20, wherein the step of controlling an amount of fuel delivered to an engine as a function of said desired air/fuel ratio, said fuel volatility and said intake of air mass occurs during a cold start.

23. A method for controlling an internal combustion engine during engine start, comprising:
providing said engine with a fuel system, an engine controller, a plurality of sensors, and a fuel volatility sensor;
sensing engine conditions using the plurality of sensors;
sensing fuel volatility with a sensing unit;
determining an intake of air mass to the engine as a function of sensed engine conditions;
selecting a desired air/fuel ratio to start said engine as a function of said sensed engine conditions; and
controlling an amount of fuel to be delivered to the engine as a function of said desired air/fuel ratio, said fuel volatility and said intake of air mass.

24. The method in claim 23, wherein sensing fuel volatility comprises measuring volatility during a previous engine on cycle.

25. The method in claim 23, wherein sensing fuel volatility with a sensing unit comprises sampling a quantity of fuel in a fuel line between a fuel pump and a fuel injector, and measuring a volatility of said quantity of fuel with a sensor.

26. A method for controlling an internal combustion engine during engine starting and initial operation, comprising:
sensing engine operating conditions with a plurality of sensors;
sensing fuel volatility with a fuel volatility sensing unit;
determining an intake of air mass to the engine based upon sensed engine operating conditions;
selecting a desired air/fuel ratio to operate said engine based upon said sensed engine conditions; and
controlling an amount of fuel to be delivered to the engine based upon said desired air/fuel ratio, said fuel volatility and said intake of air mass.

27. The method in claim 26, wherein sensing fuel volatility with a sensing unit comprises sampling a quantity of fuel in a fuel line between a fuel pump and a fuel injector and measuring a volatility of said quantity of fuel with a sensor.
